(19) United States
(12) Patent Application Publication
(10) Pub. No.: US 2012/0056853 A1
(43) Pub. Date: Mar. 8, 2012

(54) OPTICAL TOUCH DEVICE AND METHOD THEREFOR

(75) Inventor: Jun Iwamoto, Shizuoka (JP)

(73) Assignee: TOSHIBA TEC KABUSHIKI KAISHA, Tokyo (JP)

(21) Appl. No.: 13/219,851

(22) Filed: Aug. 29, 2011

(30) Foreign Application Priority Data
Sep. 3, 2010 (JP) 2010-197898

(51) Int. Cl. G06F 3/042

(52) U.S. Cl. 345/175

(57) ABSTRACT

In one embodiment, an optical touch device is disclosed. The device includes a housing having an opening through which a screen is exposed, light-emitting elements provided along a first side of the opening and configured to emit infrared light, and a drive unit configured to sequentially select and drive the light-emitting elements. The device further includes a detection control unit configured to output a timing signal synchronized with the timing of the driving operation of the drive unit and to detect a position of a blocking object on the screen. Further, the device includes light-receiving sensors, provided along a second side of the opening, opposite the first side of the opening, configured to be selected by the timing signal to output to the detection control unit a result of reception of the infrared light, the light-receiving sensors including different kinds of light-receiving sensors differing in a light-receiving characteristic.

### CROSS-REFERENCE TO RELATED APPLICATION

This application is based upon and claims the benefit of priority from Japanese Patent Application No. 2010-197898, filed on Sep. 3, 2010, the entire contents of which are incorporated herein by reference.

### FIELD

Embodiments described herein relate generally to optical touch devices and methods therefor.

### BACKGROUND

Pointing devices such as a touch display, a touch panel or the like may employ an optical, a piezoelectric or a capacitive technique. Since these techniques for pointing devices have their merits and demerits, they are properly selected depending on the requirements of the pointing devices and/or the market needs.

Among these devices, an optical touch device is a system in which a light-receiving sensor unit receives a light from a light-emitting unit. On an operation screen of the optical touch device, a plurality of light paths is arranged in vertical and horizontal directions. Touching the operation surface with a blocking object (e.g., a human finger) blocks one or more light beams which are intended to pass along light paths including the touched location, so that the light-receiving sensor unit fails to receive the blocked light beams. A coordinate of the position where the light beams are blocked is detected by a detection device to determine the touched location. Thus, the detection device determines that the blocking object (i.e., a touch pointer) is placed at the touched location.

In the related art, there is known an optical touch panel device designed to assure normal operation regardless of the places and manners in which the touch panel device is arranged. Also known is an optical touch panel where typical scanning is performed in which detection performance (or accuracy) is given a priority in the touch operation. On the other hand, when the scanning speed is given a priority, scanning is performed in such a manner as to thin out some of light-emitting elements and light-receiving sensors.

If the light-receiving sensor unit receives external disturbance light (or ambient light) from an outside light source such as direct sunlight, a fluorescent lamp or the like, it may not correctly recognize an object blocking the light paths. Thus, the optical touch device may fail to correctly determine and recognize the existence of the blocking object and the position thereof. Specifically, if the external disturbance light, of a wavelength band overlapping with the wavelength band covered by a light-receiving sensor, is incident on the light-receiving sensor arranged in the light path blocked by the object, it may cause the optical touch device to temporarily malfunction. Accordingly, the optical touch device cannot reliably operate in an environment such as outdoors or near a window where external disturbance light is strongly incident.

### BRIEF DESCRIPTION OF THE DRAWINGS

FIG. 1 is a plan view showing an optical touch device according to an embodiment.

FIG. 2 is a graph showing one example of light-receiving sensitivity characteristics of two different kinds of light-receiving sensors.

FIG. 3 is a view showing one example of a block diagram of a drive unit, a selection unit and a detection control unit.

FIG. 4 is a view showing an optical path matrix when no blocking object is present on an optical touch device according to one embodiment and no external disturbance light is incident on the optical touch device.

FIG. 5 is a view showing the optical path matrix when a blocking object is present on the optical touch device and no external disturbance light is incident on the optical touch device.

FIG. 6 is a view showing the optical path matrix when a blocking object is present on the optical touch device and an external disturbance light is incident on the optical touch device.

FIG. 7 is a view showing major components of an optical touch device in the related art.

FIG. 8 is a view showing an optical path matrix when a blocking object is present on the optical touch device and no external disturbance light is incident on the optical touch device.

FIG. 9 is a view showing the optical path matrix when a blocking object is present on an optical touch device of a first modified embodiment and an external disturbance light is incident on the optical touch device.

FIG. 10 is a view showing the optical path matrix when a blocking object is present on an optical touch device of a second modified embodiment and an external disturbance light is incident on the optical touch device.

### DETAILED DESCRIPTION

In one embodiment, an optical touch device is disclosed. The optical touch device includes a housing having an opening through which a rectangular screen is exposed, a plurality of light-emitting elements provided along a first side of the opening of the housing and configured to emit infrared light, and a drive unit configured to sequentially select and drive the light-emitting elements. The optical touch device further includes a detection control unit configured to output a timing signal synchronized with the timing of the selecting and driving operation of the drive unit and to detect a position of a blocking object existing on the screen by detecting blocked scanning light paths generated by the light-emitting elements. Further, the optical touch device includes a plurality of light-receiving sensors, provided along a second side of the opening, opposite the first side of the opening, configured to be selected by the timing signal outputted from the detection control unit to output to the detection control unit a result of reception of the infrared light emitted by the selected and driven light-emitting elements, the light-receiving sensors including different kinds of light-receiving sensors differing in a light-receiving characteristic from each other.

Embodiments will now be described in detail with reference to the drawings.

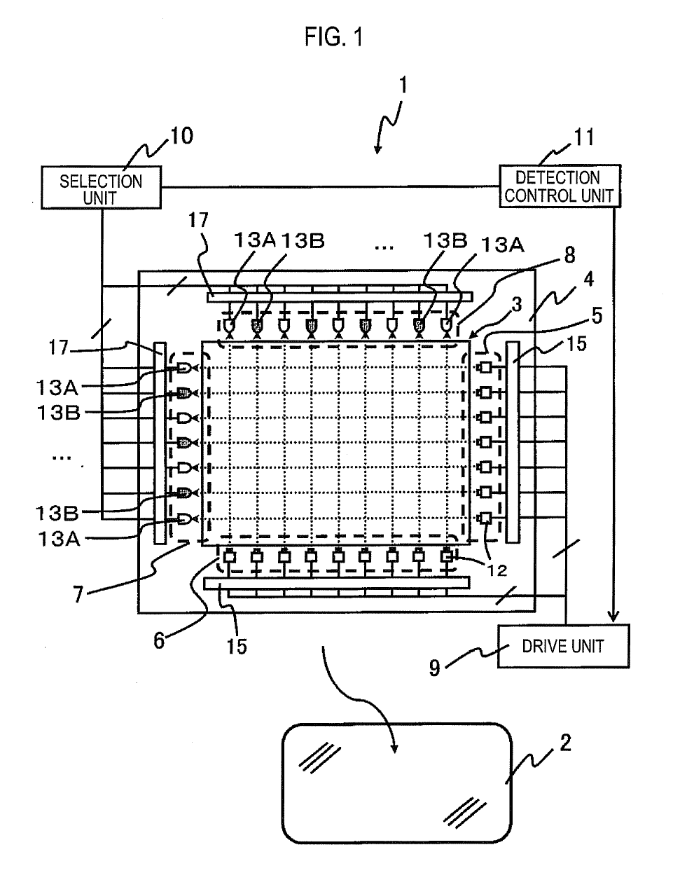

An optical touch device according to illustrative embodiments will now be described in detail with reference to FIGS. 1 through 10. Same components will be designated by like reference numerals and symbols in the respective views and thus a description thereof will be omitted to avoid duplication herein.

The optical touch device according to illustrative embodiments may be an infrared (IR) touch panel.

FIG. 1 is a plan view of a touch panel according to an illustrative embodiment. The touch panel 1 includes a housing 4 equipped with a display screen 2 and provided with a rectangular opening 3 through which the display screen 2 is exposed. The touch panel 1 further includes light-emitting devices 5 and 6 provided respectively along two adjacent sides (e.g., the right and lower sides) of the opening 3, and light-receiving devices 7 and 8 provided respectively along the opposite two adjacent sides (e.g., the left and upper sides) of the opening 3 to detect the intensities of lights coming from the light-emitting devices 5 and 6. The touch panel 1 further includes a drive unit 9 configured to drive the light-emitting devices 5 and 6, a selection unit 10 configured to selectively output a part of the electric currents into which the lights received by the light-receiving devices 7 and 8 are converted through photoelectric conversion, and a detection control unit 11 configured to detect a coordinate of the location on the display screen 2 where a blocking object such as a human finger, a touch pen, a stylus, or the like is touched, using a cross-point matrix implemented by intersecting a plurality of light paths formed between the light-emitting devices 5 and 6 and the light-receiving devices 7 and 8, respectively. The dotted lines shown in FIG. 1 indicate the light paths through which light beams propagate.

The opening 3 defines an input operation area. The housing 4 has a specified thickness. The housing 4 holds the light-emitting devices 5 and 6 and the light-receiving devices 7 and 8 therein so that the light beams emitted from the light-emitting devices 5 and 6 can travel in parallel to the surface of the opening 3 and reach respective light-receiving devices 7 and 8. Each of the light-emitting devices 5 and 6 includes a plurality of infrared light-emitting elements 12. For example, light-emitting devices (LEDs) may be employed as the light-emitting elements 12. The light-emitting elements 12 are arranged at regular intervals and emit light beams of an infrared wavelength band toward respective light-receiving elements.

The light-receiving device 7 includes a plurality of light-receiving sensors 13A and 13B. The light-receiving sensors 13A and 13B are elements configured to receive the light beams of an infrared wavelength band. Similarly, the light-receiving device 8 includes a plurality of light-receiving sensors 13A and 13B. For example, phototransistors are employed as the light-receiving sensors 13A and 13B. In this embodiment, two different kinds of the light-receiving sensors 13A and 13B configured to detect different wavelength bands are alternately arranged in the light-receiving device 7. Likewise, two different kinds of light-receiving sensors 13A and 13B configured to detect different wavelength bands are alternately arranged in the light-receiving device 8. The light-receiving sensors 13A and 13B of the light-receiving devices 7 and 8 are arranged at regular intervals while facing the respective light-emitting elements 12 of the light-emitting devices 5 and 6, with the opening 3 being interposed therebetween.

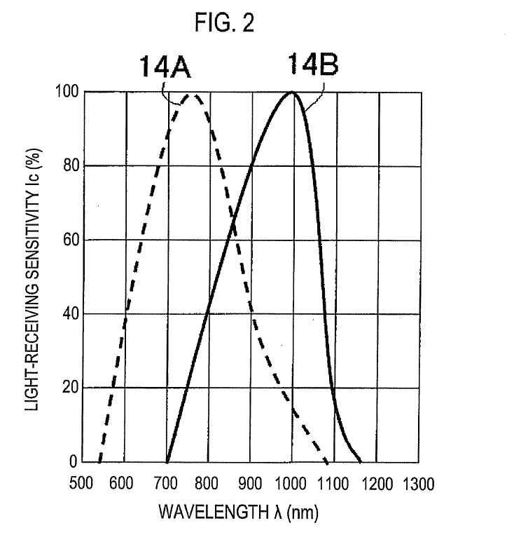

FIG. 2 is a graph depicting one example of the light-receiving sensitivity characteristics of the two kinds of light-receiving sensors 13A and 13B. In FIG. 2, one characteristic curve 14A shows the characteristic of the light-receiving sensitivity of the light-receiving sensors 13A along the wavelength axis, in which the curve of the light-receiving sensitivity reaches its peak in the wavelength band of about 750 nm. The other characteristic curve 14B indicates the characteristic of the light-receiving sensitivity of the light-receiving sensors 13B along the wavelength axis, in which the curve of the light-receiving sensitivity reaches its peak in the wavelength band of about 1000 nm. The characteristic curves 14A and 14B each have a shape spreading out toward the bottom. In one embodiment, the light-emitting elements 12 shown in FIG. 1 may emit light of a broad wavelength band including, for example, both the wavelength band close to 750 nm and the wavelength band close to 1000 nm.

When no external disturbance light is incident on the touch panel 1 and no blocking object touches the screen 2, none of the light-receiving sensors 13A and 13B respond. Herein, the expressions “the light-receiving sensors 13A and 13B respond” or “in a responsive state” mean that, for example, the light-receiving sensors 13A and 13B respond to a blocking object on the touch panel 1 in such a manner that the sensors 13A and 13B fail to receive light beams from the light-emitting elements 12, and thus do not output electric currents generated through photoelectric-conversion. Conversely, the expressions “the light-receiving sensors 13A and 13 B do not respond” or “in a non-responsive state” mean that, for example, the light-receiving sensors 13A and 13B do not respond to a blocking object on the touch panel 1 in such a manner that the sensors 13A and 13B receive light beams from the light-emitting elements 12, and thus output electric currents which are photoelectric-converted from the received light beams.

When no external disturbance light is incident on the touch panel 1 but a blocking object is present on the screen 2, light interruption or blocking occurs. Accordingly, one set or plural sets of adjacent light-receiving sensors 13A and 13B respond to the blocking object.

In this embodiment, when one or more pairs of the light-receiving sensors 13A and 13B respond, the detection control unit 11 detects a difference between electric currents of the signals outputted by the respective pairs of the light-receiving sensors 13A and 13B. For example, the detection control unit 11 scans the intensity levels of the lights received by the respective pairs of light-receiving sensors 13A and 13B alternately arranged, and detects any difference between the intensities of the lights received by the adjacent light-receiving sensors 13A and 13B. Herein, the term “intensity” or “light-receiving intensity” may refer to a power level of a received light. This determination is performed during one scan cycle. For example, when the detection control unit 11 detects that a difference between the light-receiving intensities is greater than a predetermined value, the detection control unit 11 determines that a blocking object is located on the display screen 2.

The light-receiving sensors 13A detect a light having a center wavelength of approximately 750 nm (i.e., belonging to the range of a short wavelength infrared light). The light-receiving sensors 13B detect a light having a center wavelength of approximately 1000 nm (i.e., belonging to the range of a long wavelength infrared light). For an external disturbance light which contains a greater number of band components of short wavelength infrared light than those of long wavelength infrared light, the light-receiving intensity of the light-receiving sensors 13A is higher than that of the light-receiving sensors 13B. Meanwhile, for another external disturbance light which contains a greater number of band components of long wavelength infrared light than those of short wavelength infrared light, the light-receiving intensity of the light-receiving sensors 13A is lower than that of the light-receiving sensors 13B.

If the external disturbance light is incident on the light-receiving sensors 13A and 13B, the light-receiving sensors 13A and 13B output an electric current whose intensity is greater than zero. When the external disturbance light is incident on the touch panel 1, the light-receiving sensors 13A and 13B (regardless of where they are arranged on the light-receiving devices 7 and 8) output electric currents having different intensities of greater than zero to be input to the detection control unit 11. When the external disturbance light is incident on the touch panel 1 and a blocking object touches the screen 2, one kind of the light-receiving sensors of one or more sets of the adjacent light-receiving sensors 13A and 13B remains in a responsive state due to the blocking of the light, whereas the other kind of the light-receiving sensors may remain in a non-responsive state and continue to output electric currents whose intensity is greater than zero. By detecting the difference in the current intensities between the adjacent light-receiving sensors 13A and 13B through a sweeping (i.e., sequentially detecting) operation, the detection control unit 11 can sense the touching of a blocking object despite the existence of the external disturbance light.

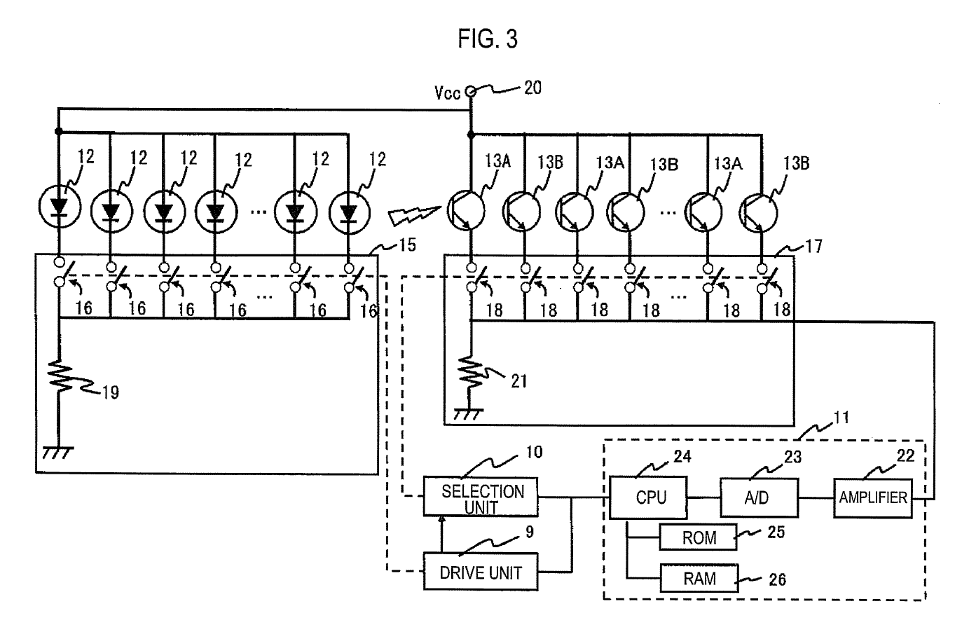

FIG. 3 is a view showing one example of a block diagram of the drive unit 9, the selection unit 10 and the detection control unit 11. The same components are designated by like reference numerals and symbols.

The drive unit 9 is connected to a drive circuit 15. The drive circuit 15 includes a plurality of switching elements 16. A pair of switching elements 16 respectively for vertical scanning and horizontal scanning is selected from the plurality of switching elements 16 at one time. Among the total light-emitting elements 12, the light-emitting elements 12 vertically arranged along, for example, the right side of the screen 2, make up the light-emitting device 5. The remaining light-emitting elements 12 horizontally arranged along, for examples, the lower side of the screen 2, make up the light-emitting device 6. The drive unit 9 drives a pair of the light-emitting elements 12 one after another, respectively in the vertical direction and in the horizontal direction, by sequentially selecting a pair of switching elements 16 respectively for vertical scanning and for horizontal scanning. That is to say, the drive unit 9 turns on the light-emitting devices 5 and 6 by selectively switching two of the switching elements 16, which in turn, turn on one of the light-emitting elements 12 of the light-emitting device 5 and one of the light-emitting elements 12 of the light-emitting device 6.

The selection unit 10 is connected to a drive circuit 17. The drive circuit 17 includes a plurality of switching elements 18. A pair of switching elements 18 is selected from the plurality of switching elements 18 respectively for vertical scanning and for horizontal scanning. Among the total light-receiving sensors 13A and 13B, the light-receiving sensors 13A and 13B vertically arranged along, for example, the left side of the screen 2, make up the light-receiving device 7. The remaining light-receiving sensors 13A and 13B horizontally arranged along, for example, the upper side of the screen 2, make up the light-receiving device 8. The selection unit 10 selects a pair the light-receiving sensors one after another, respectively in the vertical direction and in the horizontal direction, by sequentially selecting a pair of switching elements 18 respectively for vertical scanning and for horizontal scanning, at the timing synchronized with the timing of the switching of the drive unit 9. That is to say, the selection unit 10 controls the light-receiving devices 7 and 8 by selectively switching two of the switching elements 18 that correspond to the switching elements 16 switched by the drive unit 9, which in turn, operates one of the light-receiving sensors 13A (or 13B) of the light-receiving device 7 and one of the light-receiving sensors 13A (or 13B) of the light-receiving device 8.

The drive circuit 15 may include the switching elements 16 and a biasing resistor 19 and be powered by a power supply line 20. The switching elements 18, a biasing resistor 21 and the power supply line 20 may constitute the drive circuit 17.

One ends of the n light-emitting elements 12 are pulled up. The switching elements 16 are serially connected to the other ends of the light-emitting elements 12, respectively. The switching elements 16 are grounded through the resistor 19. One ends of the n light-receiving sensors 13A and 13B are pulled up. The switching elements 18 are serially connected to the other ends of the light-receiving sensors 13A and 13B, respectively. The switching elements 18 are grounded through the resistor 21.

The detection control unit 11 includes an amplifier 22, an A/D converter 23, a CPU 24, a ROM 25 and a RAM 26.

An input port of the amplifier 22 is connected to the node where the resistor 21 and the switching elements 18 are connected. Accordingly, the output of one of the light-receiving sensors 13A and 13B is selectively inputted to the input port of the amplifier 22 through the switching elements. The amplified output of the amplifier 22 is inputted to the CPU 24 through the A/D converter 23. The CPU 24 sequentially writes the intensity of the A/D-converted current coming from the output port of the amplifier 22 on the RAM 26 and generates optical path information in the storage area of the RAM 26.

The ROM 25 stores an execution program for detecting a coordinate(s) of a blocking object. The RAM 26 stores the intensity of the A/D-converted electric current outputted from one of the light-receiving sensors 13A and 13B. The CPU 24 feeds control signals to the drive unit 9 and the selection unit 10 to drive the switching elements 16 and 18, respectively. During every scanning cycle, the CPU 24 performs scanning operations, from one end of the vertical and horizontal directions, used as start positions, to the other end of the vertical and horizontal directions, used as end positions. The CPU 24 may finish the scanning of all pairs of the light-emitting elements 12 and light-receiving sensors 13A and 13B by performing plural scanning operations.

For example, the detection control unit 11 may select and drive one vertical set of the light-emitting element 12 and the light-receiving sensor 13A (or 13B), and one horizontal set of the light-emitting element 12 and the light-receiving sensor 13A (or 13B). The intersection point information of the light paths of the vertical set and the horizontal set and the light-receiving intensities of the light-receiving sensors 13A and 13B are written on the RAM 26. The detection control unit 11 sweepingly drives the light-emitting elements 12. In addition, the detection control unit 11 sweepingly detects the responsive point(s) by shifting one-by-one the intersection points of the paths of the lights traveling between the light-emitting device 5 and the light-receiving device 7, and the paths of the lights traveling between the light-emitting device 6 and the light-receiving device 8. If a blocking object is present in a certain position (i.e., a contact position) on the screen 2, the vertical and the horizontal light paths passing through the contact position are blocked. Thus, the light-receiving sensors 13A and 13B on at least one of the light paths becomes unable to receive the light beam. The number of blocked light paths may depend on the resolution or the resolving power of the light-receiving devices 7 and 8. The CPU 24 specifies the coordinate(s) of the contact position using the information on the blocked light-receiving sensors 13A and 13B. The CPU 24 performs a detection process by storing, as positional information on the contact position of the blocking object, the coordinate(s) of the points where the difference in the light-receiving intensity between the light-receiving sensors 13A and 13B is large.

The light-receiving sensors 13A and 13B are alternately arranged in the light-receiving device 7. In the light-receiving device 7, the number of the light-receiving sensors 13A may be equal to the number of the light-receiving sensors 13B. Alternatively, the number of one type of the light-receiving sensors 13A and 13B may be greater by one sensor than the number of the other type. Similarly, the light-receiving sensors 13A and 13B are also alternately arranged in the light-receiving device 8. In the light-receiving device 8, the number of the light-receiving sensors 13A may be equal to the number of the light-receiving sensors 13B. Alternatively, the number of one type of the light-receiving sensors 13A and 13B may be greater by one sensor than the number of the other type. The selection unit 10 outputs to the detection control unit 11 the electric signals outputted from two sensors i.e., one point of the light-receiving device 7 and one point of the light-receiving device 8. The detection control unit 11 is designed to detect the coordinate(s) of the position of a blocking object with the resolution or the resolving power decided by the degree of the density of the light-receiving sensors 13A and 13B.

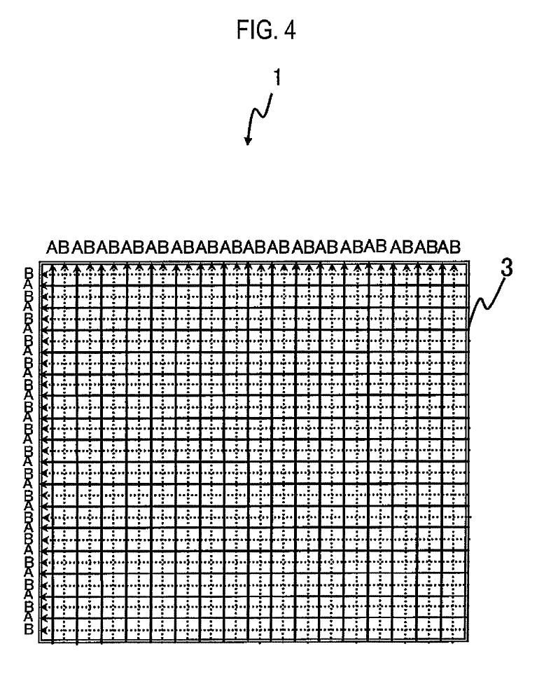

In a state that an external disturbance light is incident on the touch panel 1 of the above-described configuration and no blocking object is present on the screen 2, a command to start a scanning operation is applied to the CPU 24. For example, an independent control unit (not shown) handling the information displayed on the screen 2 transmits a command to the detection control unit 11 while displaying an image that prompts a user to make an input. Then, the CPU 24 starts its processing. The operation principle of the touch panel 1 will now be described with reference to FIG. 4.

FIG. 4 is a view showing an optical path matrix when no external disturbance light is incident on the touch panel 1 and no blocking object is present thereon. Reference symbols “A” indicate the light-receiving sensors 13A, while reference symbols “B” indicate the light-receiving sensors 13B. Solid line arrows indicate the scanning light paths of the light beams traveling from the light-emitting elements 12 to the light-receiving sensors 13A, respectively. Dotted line arrows indicate the scanning light paths of the light beams traveling from the light-emitting elements 12 to the light-receiving sensors 13B, respectively. The solid line arrows and the dotted line arrows are used to distinguish the scanning light paths leading to the light-receiving sensors 13A and the scanning light paths leading to the light-receiving sensors 13B.

The CPU 24 starts a scanning operation by selecting and driving one of the light-emitting elements 12 of the light-emitting device 5 disposed at the lowermost position of a Y-axis and one of the light-emitting elements 12 of the light-emitting device 6 disposed at the leftmost position of an X-axis. The CPU 24 sequentially selects each of the light-emitting elements 12 of the light-emitting device 5 along the positive (i.e., the upward) direction of the Y-axis and also sequentially selects each of the corresponding light-receiving sensors 13A or 13B of the light-receiving device 7 facing the light-emitting elements 12 along the positive (i.e., the upward) direction of the Y-axis. Similarly, the CPU 24 sequentially selects each of the light-emitting elements 12 of the light-emitting device 6 along the positive direction (i.e., the rightward) of the X-axis and also sequentially selects each of the corresponding light-receiving sensors 13A or 13B of the light-receiving device 8 facing the light-emitting elements 12 along the positive (i.e., the rightward) direction of the X-axis. The CPU 24 performs a scanning operation by sequentially selecting and driving the light-emitting elements 12 at a specific scanning speed. The output electric currents of the n light-receiving sensors 13A and 13B arranged along the left side and the upper side are amplified by the amplifier 22. The amplified currents of the amplifier 22 are A/D-converted by the A/D converter 23 and the light-receiving amounts of the n light-receiving sensors 13A and 13B are stored in the RAM 26 one after another.

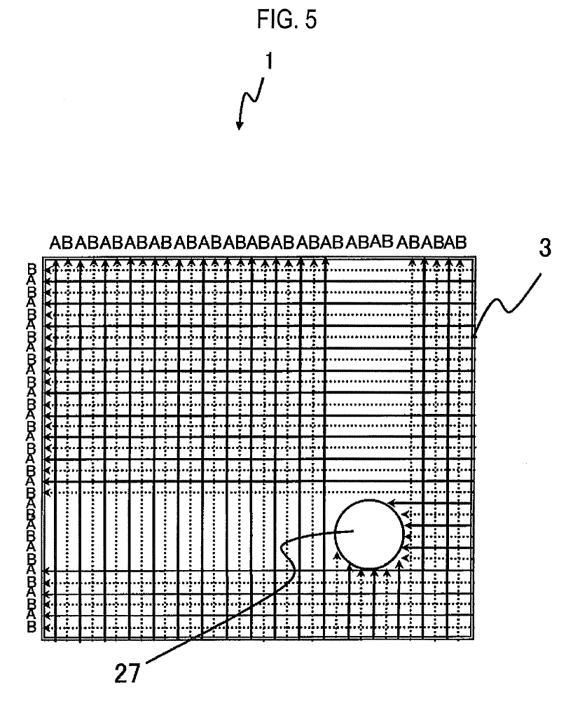

Next, the CPU 24 is instructed to perform a scanning operation when no external disturbance light is incident on the touch panel 1 and a blocking object is present thereon. FIG. 5 is a view showing the optical path matrix when no external disturbance light is incident on the touch panel 1 and a blocking object 27 is present thereon. Reference symbols “A” and “B” are the same as those indicated in FIG. 4.

A blocking object 27 such as a human finger or a touch pen makes contact with a position within a certain area in the opening 3 to block the scanning light paths intended to pass through the contact position. The light-receiving sensors 13A and 13B corresponding to such blocked scanning light paths respond at the light emission timing of the light-emitting elements 12 facing the light-receiving sensors 13A and 13B. The X and Y coordinates of the blocking object 27 are detected accordingly. The CPU 24 stores the coordinate information in the RAM 26.

Next, description will be made on a comparative example used in a situation that the external disturbance light is incident on the touch panel 1. The external disturbance light includes artificial light irradiated from a fluorescent lamp, an incandescent lamp, a mercury lamp or other lamps and natural light such as sunlight. Most kinds of light may be considered an external disturbance light, for example, except for light having a wavelength whose energy is determined depending on the band gap of a semiconductor such as a light emitted from a light-emitting diode. External disturbance light such as distant sunlight or intensive light coming from a lamp is irradiated on the touch panel 1, for example, placed within a room.

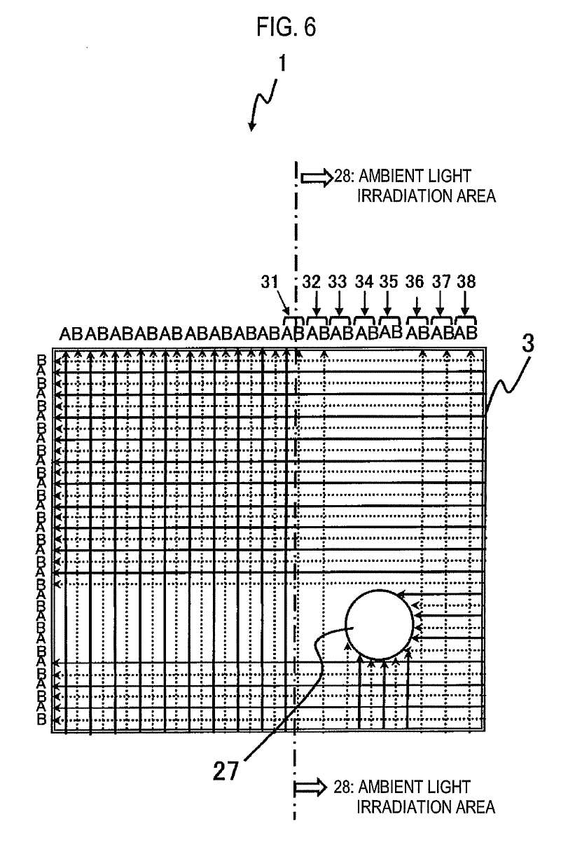

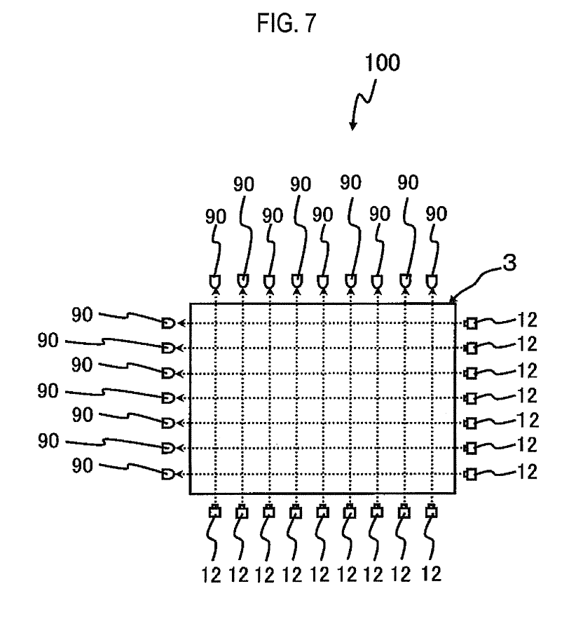

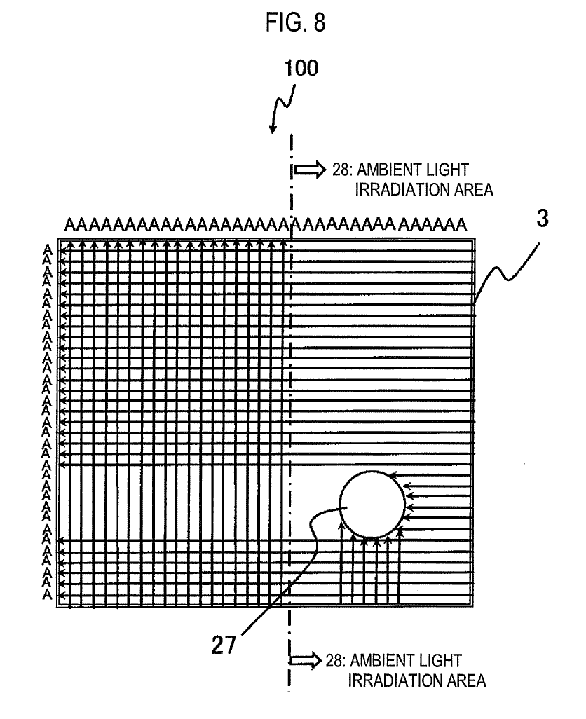

FIG. 6 is a view showing the light path matrix when an external disturbance light is incident on the touch panel 1 and a blocking object 27 is present thereon. The right part of the touch panel 1 which keeps being irradiated by the external disturbance light, for example, is designated as an external disturbance light irradiation area 28. FIG. 7 is a view showing major components of an optical touch device of the related art. FIG. 8 is a view showing a light path matrix when external disturbance light is incident on the optical touch device of the related art and a blocking object 27 is present thereon. The same components are designated by like reference numerals and symbols.

For example, a pair 31 shown in FIG. 6 indicates a pair of the light-receiving sensors 13A and 13B. Pairs 32 to 38 indicate the same. If the external disturbance light contains a greater number of band components belonging to the range of short wavelength infrared light than the band components belonging to the range of long wavelength infrared light, the light-receiving intensities of the light-receiving sensors 13A become large (whether the blocking object 27 is present or not). In the external disturbance light irradiation area 28, the light-receiving sensors 13A do not respond to the blocking object 27. Therefore, the light-receiving sensors 13A of the pairs 32 to 38 may not be used for the detection of the blocking object 27.

The detection control unit 11 scans the light-receiving intensities outputted by the pairs 32 to 38 including the alternating light-receiving sensors 13A and 13B, in the order from the pair 32 to the pair 38. For the pairs 33 to 35, the light-receiving intensities of the light-receiving sensors 13B are low. For the pairs 32, 36, 37 and 38, the detection control unit 11 detects the power levels from the light-receiving sensors 13B, whose intensities are greater than zero (and also greater than those of the pairs 33 to 35). In addition, the detection control unit 11 detects the pairs where the difference in the light-receiving intensity between the light-receiving sensors 13A and 13B among the pairs 32 to 38 is considerably great, i.e., detects that the differences are great in the pairs 33 to 35. In other words, the detection control unit 11 detects that the scanning light paths are blocked in the pairs 33 to 35. Thus, the presence of a blocking object is detected. By scanning the difference in the electric power between the adjacent light-receiving sensors 13A and 13B, the detection control unit 11 can detect the contact of the blocking object 27 even when the external disturbance light exists.

For example, the ROM 25 stores the threshold values of the following four kinds of light-receiving intensities for use in performing detecting the position of the blocking object: a first light-receiving intensity for a state that the external disturbance light is not incident and the scanning light paths are not blocked; a second light-receiving intensity for a state that the external disturbance light is incident and the scanning light paths are not blocked; a third light-receiving intensity for a state that the external disturbance light is incident and scanning light paths are blocked; and a fourth light-receiving intensity for a state that the external disturbance light is not incident and scanning light paths are blocked. When finding the position of a blocking object between the pairs 31 through 38, the detection control unit 11 detects whether the light-receiving sensors 13A and 13B respond to the blocking object or not based on the above light-receiving intensities.

Referring to FIG. 7, an optical touch panel (or optical touch device) 100 of the related art employs light-receiving sensors 90 as vertical and horizontal detection elements. The light-receiving sensors 90 serve to detect the short wavelength infrared light. The light-receiving sensors 90 are referred to as light-receiving sensors A hereinafter. The touch panel 100 exhibits the same light-receiving characteristics in the vertical direction and the horizontal direction. Reference symbols “A” in FIG. 8 refer to the light-receiving sensors.

As can be seen in FIG. 8, the optical touch panel 100 is designed to identify and detect the coordinate(s) of a blocking object 27 as a part of the light beams traveling toward the light-receiving sensors are blocked by the blocking object 27 (i.e., a interrupting object). However, for example, depending on the direction of sunlight, external disturbance light may continue to be incident on the light-receiving sensors A. If the external disturbance light is continuously being received, the light-receiving sensors A do not respond to even the blocking object 27 making contact with the touch device (i.e., the light-receiving sensors A receive substantially the same amount of light whether the blocking object makes contact with the touch device or not). As a result, the optical touch panel 100 of the related art consisting of the light-receiving sensors A becomes temporarily unable to perform a detection operation.

In contrast to the above, for the touch panel 1, even in case that some of the light-receiving sensors 13A (comparable to the light-receiving sensors A in FIG. 8) are rendered temporarily unusable by the external disturbance light as shown in FIG. 6, the light-receiving sensors 13B (which may be referred to as light-receiving sensors B) differing in the light-receiving characteristic can detect the blocking object 27. In this case, the malfunctioning of the touch panel 1 can be prevented.

With the present embodiment of this configuration, the touch panel 1 employs the light-receiving sensors 13A and 13B differing in the light-receiving characteristic from each other. Therefore, the touch panel 1 can be used even in an environment where external disturbance light causes the malfunctioning of the optical touch panel 100, for example: the touch panel 1 is located in a place where intensive sunlight may be irradiated (e.g., close to a window), or as sunlight time-dependently changes from morning to evening, or various types of illumination light is irradiated. Illumination light includes the light of indoor decorative illumination devices and the light of LEDs or neon tubes used in advertisements or signs. The touch panel 1 can be used without causing any errors even when the decorative illumination devices or the like are kept turned on or even when they are blinking at night.

This disclosure provides a method of reducing the influence of external disturbance light on the touch panel 1, thereby realizing a technical solution against the external disturbance light in an optical touch device.

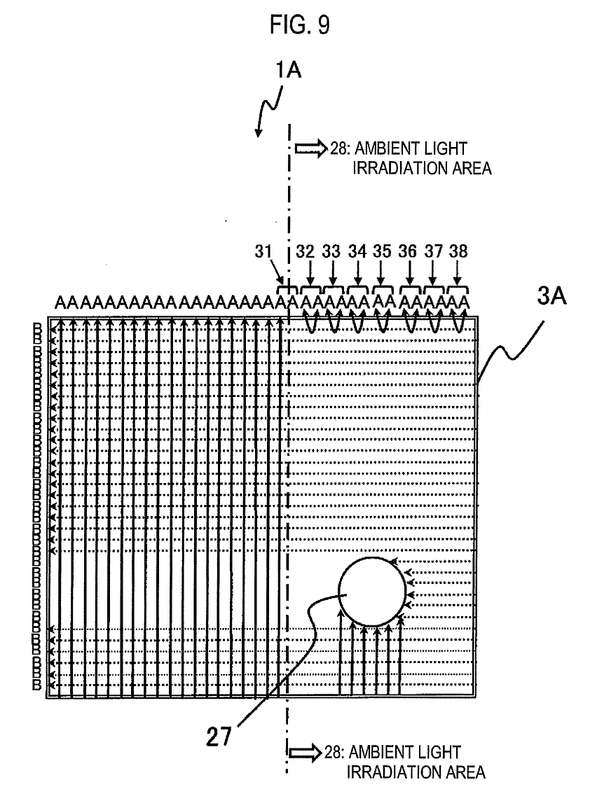

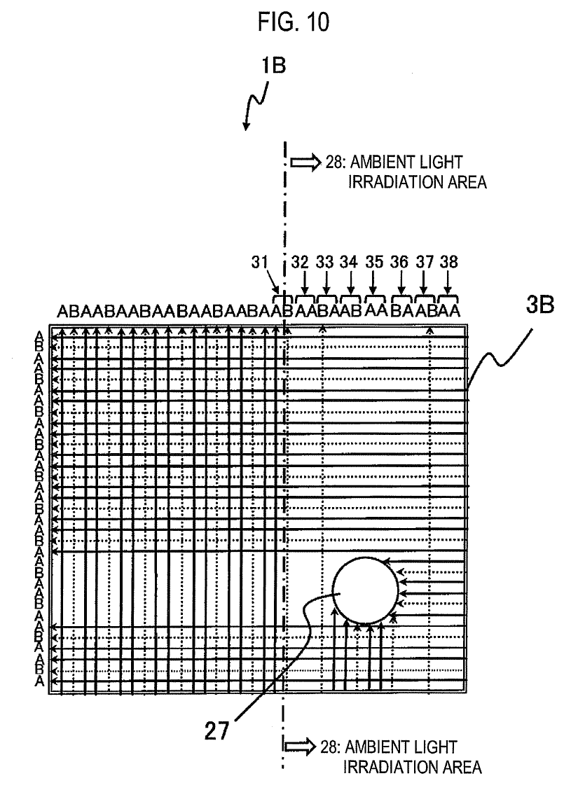

Two modified embodiments will now be described with reference to FIGS. 9 and 10, respectively. The optical touch devices according to the modified embodiments have a similar configuration as that of the touch panel 1 shown in FIG. 1.

In FIG. 9, there is shown a light path matrix where an external disturbance light is incident on the optical touch device of a first modified embodiment and a blocking object 27 is present on the optical touch device. The same components are designated by like reference numerals and symbols. As shown in FIG. 9, the light-receiving sensors 13A designated as “A” are arranged along the upper side, and the light-receiving sensors 13B designated as “B” are arranged along the left side. Solid line arrows indicate the scanning light paths of light beams traveling from the light-emitting elements 12 to the light-receiving sensors 13A. Dotted line arrows indicate the scanning light paths of light beams traveling from the light-emitting elements 12 to the light-receiving sensors 13B.

For example, in a touch panel 1A of this configuration, the detection control unit 11 scans the light-receiving intensities of the alternately-arranged pairs 31 through 38 in order from the pair 31 to the pair 38. The detection control unit 11 detects that the light-receiving intensities of the pairs 34 and 35 are lower than the light-receiving intensities of the pairs 31, 32, 33, 36, 37 and 38. It is possible for the detection control unit 11 to detect that the light-receiving sensors 13A of the pairs 34 and 35 respond to a blocking object on the touch panel 1A.

In the case that the touch panel 1A is placed under an intense fluorescent lamp, the illumination light (including light components belonging to the range of light-receiving wavelength band of the light-receiving sensors 13A) having a specific light intensity may be continuously irradiated on the touch panel 1A. In the first modified embodiment, the touch panel 1A is provided with the light-receiving sensors 13B that have the light-receiving sensitivity in the wavelength band differing from the dominant wavelength band of the illumination light irradiated from the fluorescent lamp.

For example, when the touch panel 1A is placed and used under a fluorescent lamp in an indoor area, the external disturbance light having a specific light intensity continues to be incident on the touch panel 1A. The touch panel 1A can be used in a reliable manner at any time by employing a structure specialized for specific external disturbance light such as the light of a fluorescent lamp.

FIG. 10 is a view showing a light path matrix where an external disturbance light is incident on the optical touch device of a second modified embodiment and a blocking object 27 is present on the optical touch device. Solid line arrows indicate the scanning light paths of light beams traveling from the light-emitting elements 12 to the light-receiving sensors 13A. Dotted line arrows indicate the scanning light paths of light beams traveling from the light-emitting elements 12 to the light-receiving sensors 13B.

In the touch panel 1B shown in FIG. 10, the light-receiving sensors 13A, used in the example illustrated as the optical touch device of the related art, and the light-receiving sensors 13B, differing in the light-receiving characteristic from the light-receiving sensors 13A, are arranged at different (or irregular) intervals. For example, the light-receiving sensors in the order of “B,” “A” and “A” are repeatedly arranged along the vertical row so that the interval between the light-receiving sensors 13B is different than that between the light-receiving sensors 13A.

With the touch panel 1B of this configuration, the detection control unit 11 scans the power levels of the light-receiving of the pairs 31 through 38. In the pairs 34 and 36, the light-receiving intensities of the light-receiving sensors 13B is detected to be low. For the pairs 33 and 37, the light-receiving intensities of the light-receiving sensors 13B greater than zero (and also greater than those of the pairs 34 and 36) is detected. The detection control unit 11 detects that the scanning optical paths are blocked for the pairs 34 and 36 or, consequently, the pairs 34 through 36.

Even arranging a small number of light-receiving sensors 13B in an optical touch device which are robust against external disturbance light of a specific time of day, e.g., in the morning and evening, can make the optical touch device usable at any time. The expression “small number” means that the number of the light-receiving sensors 13B is smaller than the total number of the light-receiving sensors 13A and 13B.

With the optical touch devices of the modified embodiments set forth above, the touch panel 1A or 1B can be used even in an environment where an external disturbance light causes the optical touch panel 100 to be inoperable, for example: the touch panel 1A or 1B is located in a place where intensive sunlight may be irradiated (e.g., close to a window), or as sunlight time-dependently changes from morning to evening, or various types of illumination light is irradiated.

The present invention is not limited to the embodiments described above but may be embodied by modifying the components without departing from the scope of the invention. While the optical touch device is applied to a touch panel in the foregoing embodiments, it may be used in the touch screen of a POS terminal device, a videophone and a navigation system or in the pointing device of a cathode-ray tube and a plasma display.

In the foregoing embodiments, the light-receiving levels of the light-receiving sensors 13A and 13B are scanned to detect the position of a blocking object, and the point where the light-receiving levels of greater difference are observed is regarded as the position of a blocking object. The method of detecting the position of a blocking object is not limited thereto. It goes without saying that the CPU 24 can detect the position of a blocking object using many different algorithms. The superiority of the present invention is not impaired even if the invention is embodied by merely modifying the detection method. Such modifications fall within the scope of the invention or its equivalents defined in the claims.

Further, the present disclosure may be modified by, for example, appropriately arranging the plurality of elements disclosed with respect to the above described embodiments. For example, some of the elements depicted in the embodiments may be omitted.

What is claimed is:

1. An optical touch device, comprising:
a housing having an opening through which a rectangular screen is exposed;
a plurality of light-emitting elements provided along a first side of the opening of the housing and configured to emit infrared light;
a drive unit configured to sequentially select and drive the light-emitting elements;
a detection control unit configured to output a timing signal synchronized with the timing of the selecting and driving operation of the drive unit and to detect a position of a blocking object existing on the screen by detecting blocked scanning light paths generated by the light-emitting elements; and
a plurality of light-receiving sensors, provided along a second side of the opening, opposite the first side of the opening, configured to be selected by the timing signal outputted from the detection control unit to output to the detection control unit a result of reception of the infrared light emitted by the selected and driven light-emitting elements, the light-receiving sensors including different kinds of light-receiving sensors differing in a light-receiving characteristic from each other.

2. The device of claim 1, further comprising:
a plurality of light-emitting elements provided along a third side of the opening of the housing adjacent to the first side and configured to emit infrared light; and
a plurality of light-receiving sensors, provided along a fourth side of the opening, opposite the third side of the opening.

3. The device of claim 1, wherein the light-receiving sensors comprises at least a pair of adjacent light-receiving sensors differing in the light-receiving characteristic from each other.

4. The device of claim 3, wherein the light-receiving sensors further comprises one or more additional pairs of adjacent light-receiving sensors differing in the light-receiving characteristic from each other.

5. The device of claim 1, wherein the different kinds of light-receiving sensors have different light-receiving sensitivities with respect to a wavelength band and are configured to output electric powers of the different light-receiving intensities with respect to external disturbance light, and
wherein the detection control unit is configured to scan the light-receiving intensities of the light-receiving sensors and to detect the position of the blocking object based on a difference in the light-receiving intensities.

6. The device of claim 5, wherein the detection control unit detects the position of the blocking object using a first light-receiving intensity for a state that the external disturbance light is not incident and the scanning light paths being are not blocked, a second light-receiving intensity for a state that the external disturbance light is incident and the scanning light paths are not blocked, a third light-receiving intensity for a state that the external disturbance light is incident and the scanning light paths are blocked, and a fourth light-receiving intensity for a state that the external disturbance light is not incident and the scanning light paths are blocked.

7. A method for use in an optical touch device including a plurality of light-emitting elements configured to respectively emit light beams in parallel to a screen of the optical touch device and a plurality of light-receiving sensors configured to respectively receive the emitted light beams, the light-receiving sensors including different kinds of light-receiving sensors differing in a light-receiving characteristic, the method comprising:
detecting light-receiving intensities received by the light-receiving sensors, respectively; and
detecting a position of a blocking object existing on the screen by detecting blocked scanning light paths of the emitted light beams based on the detected light-receiving intensities.

8. The method of claim 7, wherein the light-receiving sensors comprises at least a pair of adjacent light-receiving sensors that differ in the light-receiving characteristic from each other, and
wherein the method further comprises:
detecting a pair of adjacent ones of the light-receiving sensor which receive different light-receiving intensities to detect the interrupted scanning light paths.

9. The method of claim 7, wherein the different kinds of light-receiving sensors have different light-receiving sensitivities with respect to a wavelength band and are configured to output electric powers of different light-receiving intensities with respect to external disturbance light, and
wherein the method further comprises:
scanning the light-receiving intensities of the light-receiving sensors; and
detecting the position of the blocking object based on a difference in the light-receiving intensities.

10. The method of claim 9, wherein the detecting the position of the blocking object uses a first light-receiving intensity for a state that the external disturbance light is not incident and the scanning light paths being are not blocked, a second light-receiving intensity for a state that the external disturbance light is incident and the scanning light paths are not blocked, a third light-receiving intensity for a state that the external disturbance light is incident and the scanning light paths are blocked, and a fourth light-receiving intensity for a state that the external disturbance light is not incident and the scanning light paths are blocked.
